(19) United States
(12) Patent Application Publication
(10) Pub. No.: US 2008/0194327 A1
(43) Pub. Date: Aug. 14, 2008

(54) Processing Game Scenes in a Gaming Machine

(76) Inventors: Peter R. Anderson, Chicago, IL (US); John Lee Griffin, Chicago, IL (US)

Correspondence Address: SCHWEGMAN, LUNDBERG & WOESSNER, P.A., P.O. BOX 2938, MINNEAPOLIS, MN, 55402, US

(21) Appl. No.: 11/570,275

(22) PCT Filed: Jun. 14, 2005
(86) PCT No.: PCT/US05/21201

§ 371 Date: Oct. 10, 2007

Related U.S. Application Data
(60) Provisional application No. 60/579,633, filed on Jun. 15, 2004.

(51) Int. Cl. A63F 13/00

(52) U.S. Cl. 463/32; 463/20

(57) ABSTRACT

A method and apparatus for processing game scenes in a gaming machine are described herein. In one embodiment, the method includes presenting a first game setting, wherein the first game setting includes a plurality of game elements. The method also includes selecting a game element from the plurality of game elements, and presenting a second game setting, wherein presenting the second game setting includes enlarging the game element to show additional details of the game element. The method includes conducting a bonus event inside the second game setting.

### RELATED APPLICATION

This application claims the benefit of U.S. Provisional Application Ser. No. 60/579,633 filed Jun. 15, 2004, which is incorporated herein by reference.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### FIELD

This invention relates generally to the field of gaming and more particularly to processing game scenes in a gaming machine.

### BACKGROUND

As gaming devices evolve, they continue to provide new and entertaining ways of presenting gaming content. One conventional way of increasing the entertainment value of casino-style video games, such as video slots, video poker, video blackjack, and the like, is to offer a base game and bonus events. A base game includes all game events that contribute to determining and/or indicating the game's primary outcome. For example, in a video slot machine game, the base game includes spinning and stopping the reels to indicate the game's primary outcome.

A bonus event includes one or more game events triggered from the base game. The outcomes of these bonus events are determined, and displayed, in a different manner than primary outcomes of the base game. These bonus outcomes are determined by either random selection by the gaming device, or by a combination of player input and random selection by the gaming device.

One disadvantage of many prior art gaming devices is that players quickly become disinterested in repetitive bonus event content. Another disadvantage of many prior art gaming devices is that they rarely offer a variety of game settings large enough to captivate players' attention.

### SUMMARY

A method and apparatus for processing game scenes in a gaming machine are described herein. In one embodiment, the method includes presenting a first game setting, wherein the first game setting includes a plurality of game elements. The method also includes selecting a game element from the plurality of game elements, and presenting a second game setting, wherein presenting the second game setting includes enlarging the game element to show additional details of the game element. The method includes conducting a bonus event inside the second game setting.

In one embodiment, the apparatus includes a primary display unit to present a first game setting, wherein the first game setting includes a plurality of game elements. The apparatus also includes a gaming control unit to select a game element from the plurality of game elements, and to cause a second game setting to be presented on the primary display unit, wherein presentation of the second game setting includes enlarging the game element to show additional details of the game element, and wherein a bonus event is conducted inside the second game setting.

### BRIEF DESCRIPTION OF THE FIGURES

The present invention is illustrated by way of example and not limitation in the Figures of the accompanying drawings in which:

FIG. 1 shows a block diagram of a system 100 for processing game scenes in a gaming device;

FIG. 2 illustrates a game setting including a plurality of game elements, according to exemplary embodiments of the invention;

FIG. 3 is a flow diagram illustrating operations for processing and presenting game settings in a gaming device, according to exemplary embodiments of the invention;

FIG. 4 depicts an enlarged game element superimposed over a game setting, according to embodiments of the invention;

FIG. 5 depicts a further enlarged game element superimposed over a game setting, according to exemplary embodiments of the invention;

FIG. 6 depicts a game element enlarged to cover an entire game setting, according to embodiments of the invention;

FIG. 7 is a flow diagram illustrating operations for conducting a bonus event in a second or other subsequent game setting, according to exemplary embodiments of the invention;

FIG. 8 depicts an enlarged portion of a game setting, according to embodiments of the invention;

FIG. 9 depicts a portion of a game setting that has been enlarged to cover the entire game setting, according to embodiments of the invention; and

FIG. 10 is a perspective view of a gaming device, according to exemplary embodiments of the invention.

### DESCRIPTION OF THE EMBODIMENTS

Systems and methods for processing game scenes in a gaming machine are described herein. In the following description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Moreover, in this description, the phrase “exemplary embodiment” means that the embodiment being referred to serves as an example or illustration.

Herein, block diagrams illustrate exemplary embodiments of the invention. Also herein, flow diagrams illustrate operations of the exemplary embodiments of the invention. The operations of the flow diagrams will be described with reference to the exemplary embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Moreover, it should be understood that although the flow diagrams depict serial operations, certain embodiments could perform certain of those operations in parallel.

This description of the embodiments is divided into three sections. In the first section, a system level overview is presented. In the second section, methods for using exemplary operations are described. In the third section, an exemplary gaming device is described.

### System Level Overview

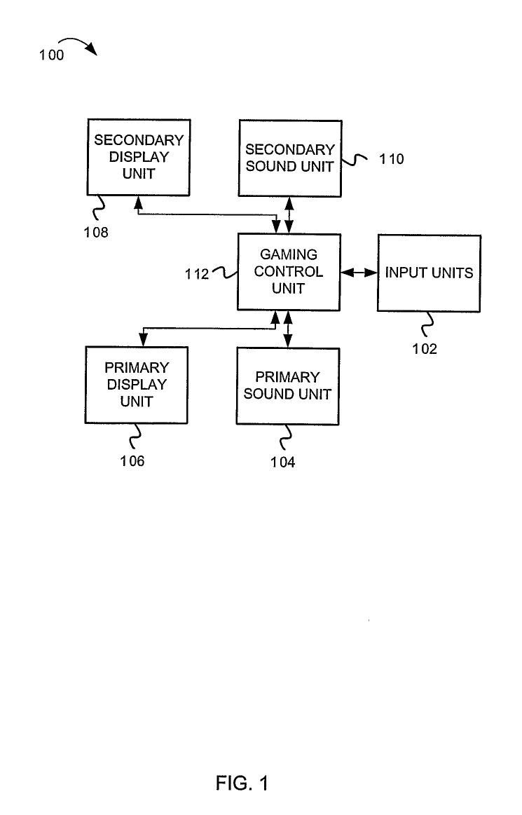

This section provides a system level overview of exemplary embodiments of the invention. FIG. 1 shows a block diagram of a system 100 for processing game scenes in a gaming device. Operations of the system components are described in the following section.

The system 100 includes one or more input units 102, which are connected to a gaming control unit 112. The input units 102 can be buttons, knobs, switches, voice-recognition devices, touchscreen display buttons, trackballs, or any other suitable input device. The gaming control unit 112 includes logic (not shown) for conducting a casino game such as video poker, video slots, video blackjack, keno, video roulette, or any other suitable casino style game. In particular, the gaming control unit 112 includes logic for processing graphics and audio for presentation via audio and video output devices. According to embodiments, the gaming control unit 112 can include queues, stacks, or other data structures necessary for performing the functionality described herein. Moreover, the gaming control unit 112 can be divided into any number of suitable elements, which can be communicatively coupled using any suitable communication method (e.g., message passing, parameter passing, signals, etc.). The gaming control unit 112 and any other component of system 100 can include machine-readable media including instructions for performing operations described herein. Machine-readable media includes any mechanism that provides (i.e., stores and/or transmits) information in a form readable by a machine (e.g., a computer). For example, a machine-readable medium includes read only memory (ROM), random access memory (RAM), magnetic disk storage media, optical storage media, flash memory devices, electrical, optical, acoustical or other forms of propagated signals (e.g., carrier waves, infrared signals, digital signals, etc.). According to embodiments of the invention, the components of the system 100 can include other various types of logic (e.g., digital logic) for processing game scenes on a gaming device, as described herein.

The gaming control unit 112 is connected to a primary sound unit 104 and a secondary sound unit 110. The primary and secondary sound units can be speakers or other suitable sound projection devices. The primary and secondary sound units receive audio output data from the gaming control unit and present the audio output data to players and onlookers.

The gaming control unit 112 is also connected to a primary display unit 106 and a secondary display unit 108. The primary and secondary display units can be cathode ray tubes (CRT), liquid crystal displays (LCD), projection displays, plasma screens, projection LCDs, or any other suitable video presentation device. The primary and secondary display units can be touchscreen devices capable of receiving player input. The primary and secondary display units receive video presentation data from the gaming control unit 112 and display that data to players and onlookers.

While the system 100 includes both primary and secondary sound and display units, alternative embodiments include additional display and sound units. However, other embodiments include only one display unit and one sound unit. As noted above, the functionality of the components of the system 100 will be described in greater detail below.

### Exemplary Operations

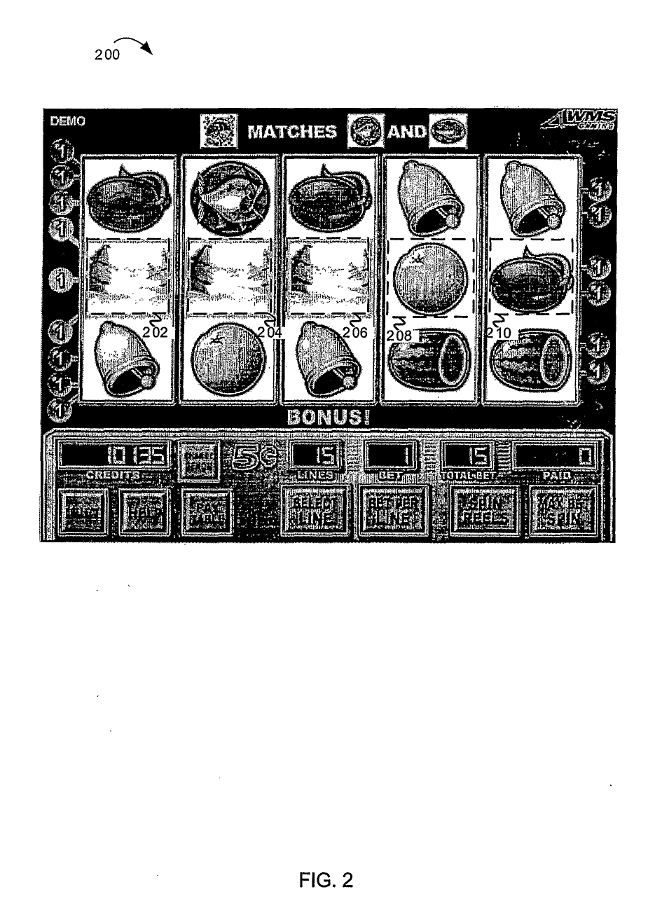

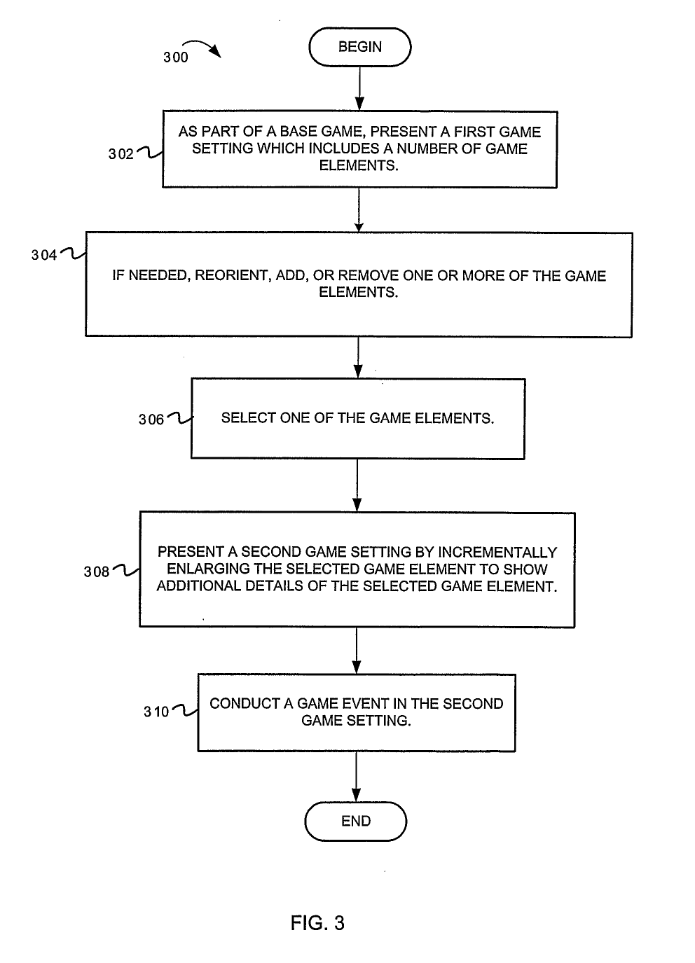

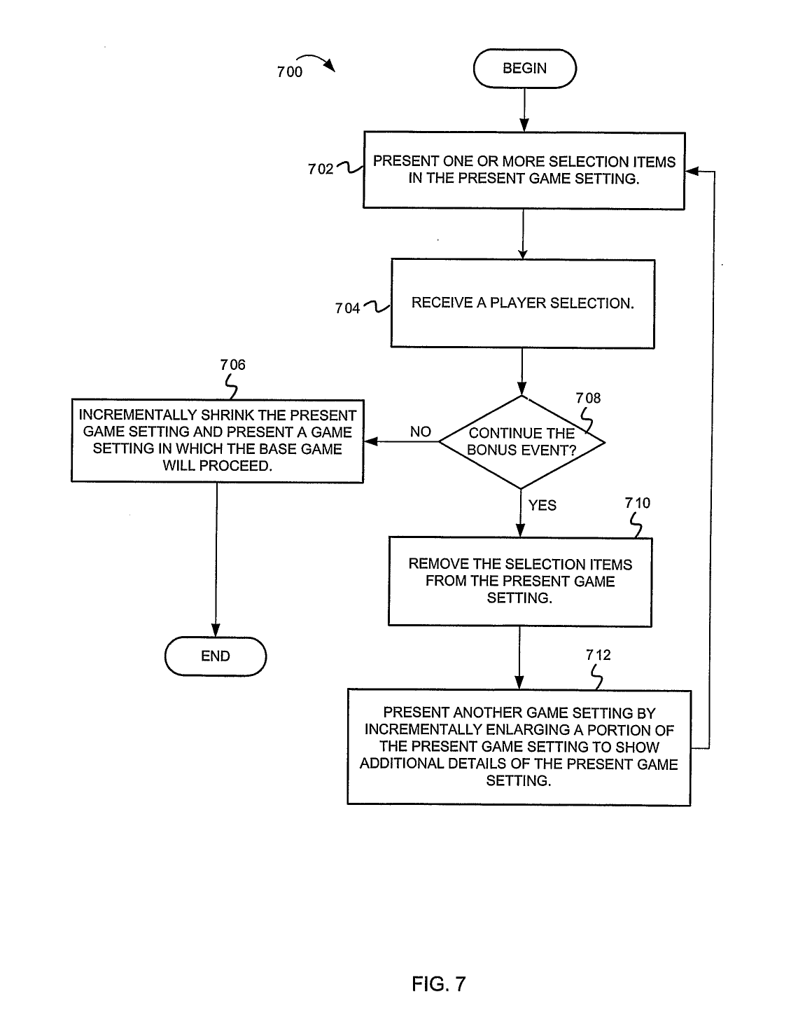

This section describes exemplary operations of the system 100 (described above). FIGS. 3 and 7 are flow diagrams describing operations for processing game scenes in a gaming device, while FIGS. 2, 4-6, and 8-9 are game settings from one or more video display devices.

FIG. 2 illustrates a game setting including a plurality of game elements, according to exemplary embodiments of the invention. According to embodiments, game settings can be presented as part of a base game or bonus event. As shown in FIG. 2, the game setting 200 includes several game elements. In particular, the game elements include a plurality of reel symbols (shown as 204, 206, 208, and 210). Although the game setting 200 illustrates game elements used with a video slot machine game, a game setting can alternatively include game elements suitable for use with any casino video game (e.g., video poker, video blackjack, video roulette, etc.).

FIG. 3 is a flow diagram illustrating operations for processing and presenting game settings in a gaming device, according to exemplary embodiments of the invention. The flow diagram 300 will be described with reference to the exemplary system 100 of FIG. 1. The flow diagram 300 commences at block 302.

At block 302, as part of a base game, a first game setting that includes a number of game elements is presented. For example, as part of a base game, the gaming control unit 112 transmits display data to the primary display unit 106, where the display data includes a first game setting that includes a number of game elements. In one embodiment, the first game setting is similar to the game setting 200 shown in FIG. 2. The flow continues at block 304.

At block 304, if needed, one or more of the game elements are reoriented, added, or removed. For example, if needed, the gaming control unit 112 reorients, adds, or removes one or more of the game elements of the game setting 200. As a more specific example, the gaming control unit 112 can reorient, add, or remove one or more of the reel symbols of the game setting 200. For example, the gaming control unit 112 can reorient the reel symbols by spinning the reels 212. In a video roulette game setting, the gaming control unit 112 can reorient the game elements by spinning the roulette wheel. Alternatively, in a video poker game, the gaming control unit 112 can reorient, add, and remove game elements by dealing and picking-up cards. The flow continues at block 306.

At block 306, one of the game elements is selected. For example, the gaming control unit 112 selects one of the reel symbols (202, 204, 206, 208, and 210) of the first game setting 200. Alternatively, the gaming control unit 112 could receive a have element selection from a player through the input units 102. The flow continues at block 308.

At block 308, a second game setting is presented by incrementally enlarging the selected game element to show additional details of the selected game element.

For example, the gaming control unit 112 presents a second game setting by incrementally enlarging game element 206 to show additional details of game element 206. The gaming control unit 112 can present the second game setting on the primary or secondary display unit. In one embodiment, the gaming control unit 112 enlarges the selected game element so that it covers the entire first game setting 200. Alternatively, the gaming control unit 112 can enlarge the selected game element to any size smaller than the first game setting. In one embodiment, the gaming control unit 112 enlarges the game element before or after temporarily graphically manipulating the game element (e.g., stretching, bending, and/or folding, the game element).

In one embodiment, the gaming control unit 112 enlarges the selected game element by performing mathematical operations on image data that represents the game element. For example, the gaming control unit 112 can increase the image size by increasing the display area and number of pixels used for displaying the game element image. If the game element's image data does not include enough detail to increase the image size at a given resolution, the gaming control unit 112 can decrease the resolution at which the mathematically enlarged image is displayed. In one embodiment, after or while enlarging a game element, the gaming control unit 112 can modify the enlarged game element by changing the display perspective. For example, the gaming control unit 112 can pan (right, left, up or down) to show different details of the game element.

Using mathematical operations to increase the image size of a game element reduces the amount of system resources needed for presenting enlarged game elements. When mathematical operations are used to enlarge a game element, there is no need to store numerous differently sized images of a game element, where each image occupies part of the system's limited storage space. In one embodiment, only one representation of the image is stored, while in alternative embodiments, more than one image is stored.

The flow continues at block 310.

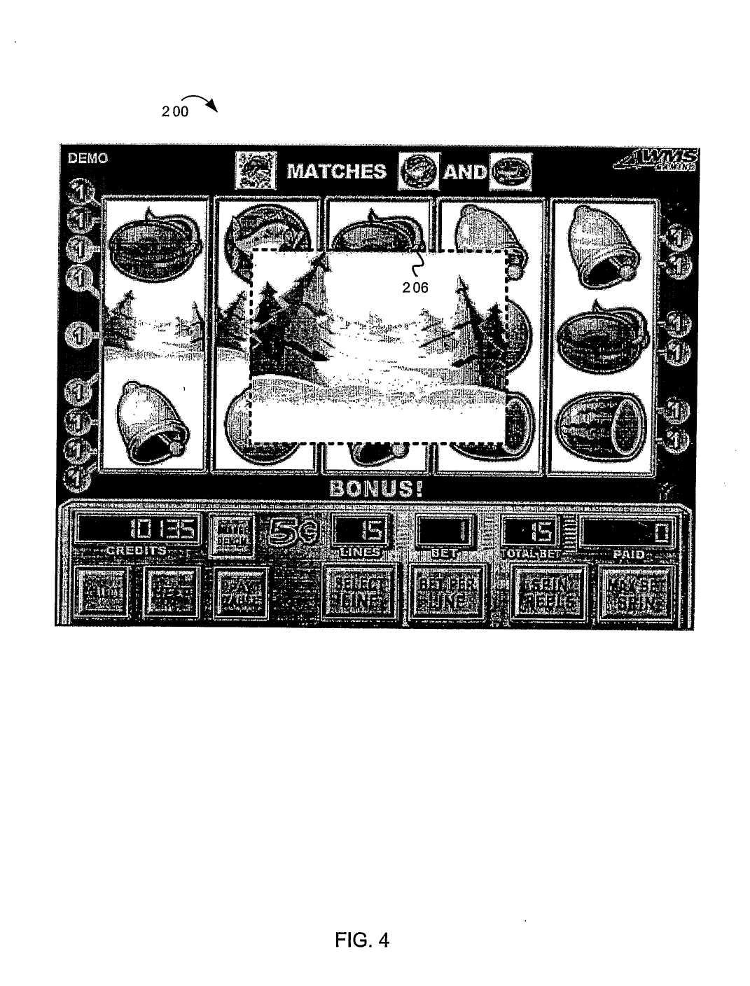

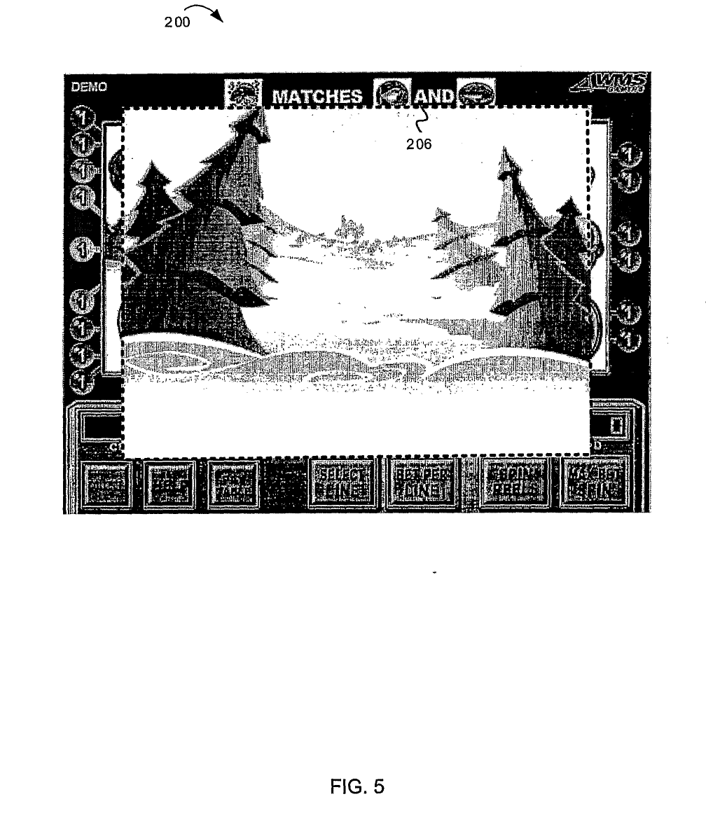

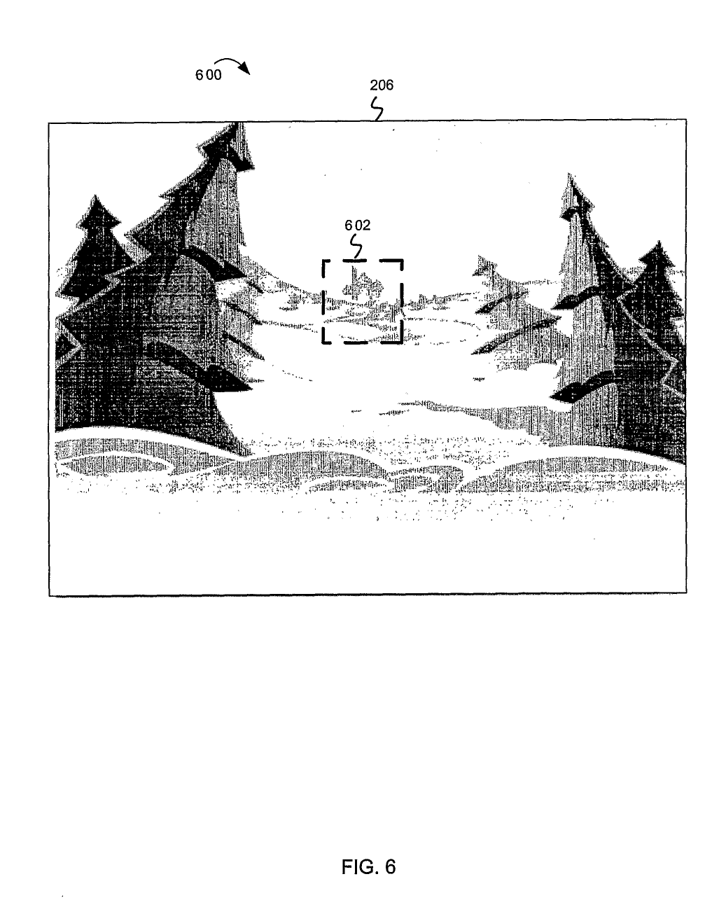

The discussion will briefly diverge from the flow diagram 300 of FIG. 3 to FIGS. 4-6, which show how the system 100 can present a second game setting by incrementally enlarging a game element to reveal additional details. FIG. 4 depicts an enlarged game element superimposed over a game setting, according to embodiments of the invention. In particular, FIG. 4 shows the reel symbol 206 enlarged and superimposed over the first game setting 200. FIG. 5 depicts a further enlarged game element superimposed over a game setting, according to exemplary embodiments of the invention. In particular, FIG. 5 shows the reel symbol 206 further enlarged and superimposed over the first game setting 200. In one embodiment, the game element (e.g., reel symbol 206) is enlarged to entirely cover the first game setting. FIG. 6 depicts a game element enlarged to cover an entire game setting, according to embodiments of the invention. As shown in FIG. 6, reel symbol 206 covers the first setting 100. As the game element (e.g., reel symbol 206) becomes larger in each of FIGS. 4-6, additional details of the game element are revealed. For example, as shown in FIG. 6, additional details 602 have been revealed as the game element has increased in size. The enlarged game element constitutes a second game setting 600.

Referring back to FIG. 3, the discussion continues at block 310. At block 310, a game event is conducted in the second game setting. For example, the gaming control unit 112 conducts a bonus event in the second game setting 600. Alternatively, the gaming control unit 112 can continue the base game from inside the second game setting 600. From block 310, the flow ends.

While FIGS. 2-6 described game settings and operations for processing game settings in the gaming device, FIGS. 7-9 describe additional game settings and operations for conducting a bonus event from within a second or subsequent game setting.

FIG. 7 is a flow diagram illustrating operations for conducting a bonus event in a second game setting or other subsequent game settings, according to exemplary embodiments of the invention. The flow diagram 700 will be described with reference to the system 100 of FIG. 1. The flow diagram 700 commences at block 702.

At block 702, one or more selection items are presented in the present game setting. For example, the gaming control unit 112 presents a number of selection items in the second game setting 600. The selection items can be icons or graphics presented on the primary or secondary display unit.

At block 704, a player selection is received. For example, the gaming control unit 112 receives a selection item selection from one of the input units 102. In one embodiment, the player selects a selection item by pressing the selection item on the primary display unit's touchscreen. From block 704, the flow continues at block 708.

At block 708, it is determined whether the bonus event continues. For example, the gaming control unit 112 determines whether the player selected a selection item that will cause the bonus event to continue. If the bonus event continues, the flow continues at block 710. Otherwise, the flow continues at block 706.

At block 706, the present game setting is incrementally shrunken and a game setting in which the base game continues is presented. For example, the gaming control unit 112 incrementally shrinks the present game setting (e.g., the second game setting 600). The gaming control unit 112 also presents a game setting in which the base game will continue (e.g., the first game setting 200). From block 706, the flow ends.

At block 710, the selection items are removed from the present game setting. For example, the gaming control unit 112 removes the selection items from the second game setting 600. As a result, the second game setting 600 appears as shown in FIG. 6. From block 710, the flow continues at block 712.

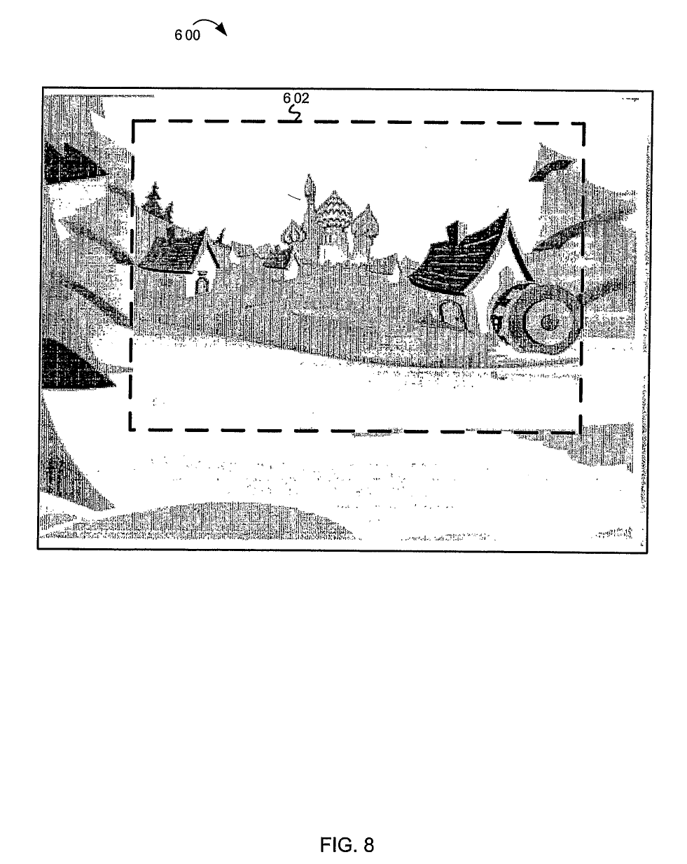

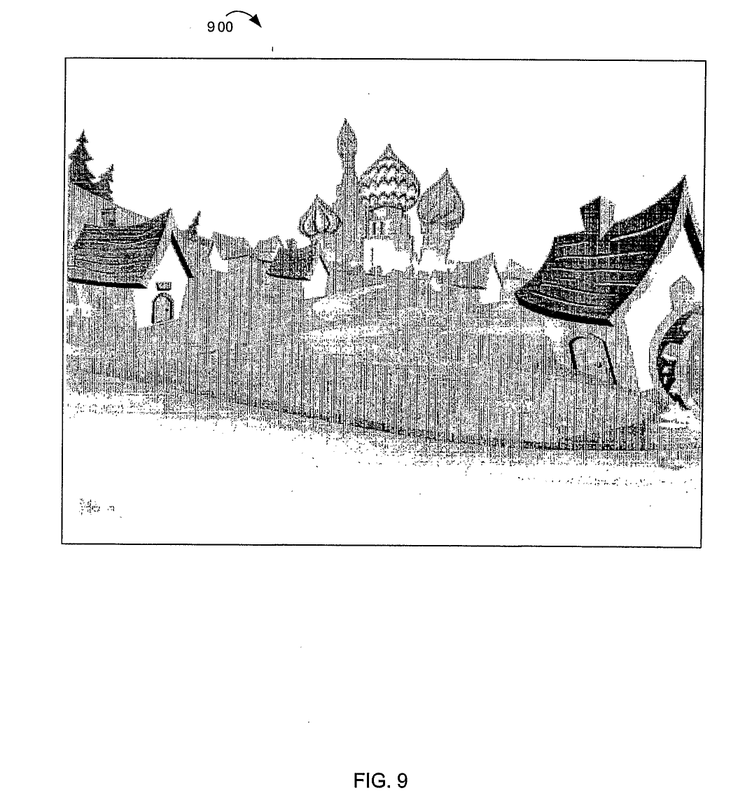

At block 712, another game setting is presented by enlarging a portion of the present game setting to show additional details of a portion of the present game setting. For example, referring to FIGS. 6, the gaming control unit 112 presents another game setting by enlarging the portion 602 of the second game setting 600. The gaming control unit 112 can enlarge the portion of the present game setting to any suitable size. After the portion 602 is enlarged, additional details become visible, as shown in FIGS. 8 and 9.

FIG. 8 depicts an enlarged portion of a game setting, according to embodiments of the invention. In particular, FIG. 8 shows the game setting portion 602 enlarged and superimposed over the second game setting 600. In FIG. 8, the enlarged game setting portion 602 constitutes another game setting. FIG. 9 depicts a portion of a game setting that has been enlarged to cover the entire game setting, according to embodiments of the invention. In particular, in FIG. 9, the game setting portion 602 has been enlarged to form another game setting 900, which covers the second game setting 600. As shown in FIGS. 8 and 9, the enlarged game setting portions show additional details about the game setting from which they were part of.

Referring to block 712 of FIG. 3, from 712, the flow continues at block 702. As is evident from the flow diagram 700, so long as the bonus event continues, the gaming control unit 112 can create additional game settings.

### Exemplary Gaming Device

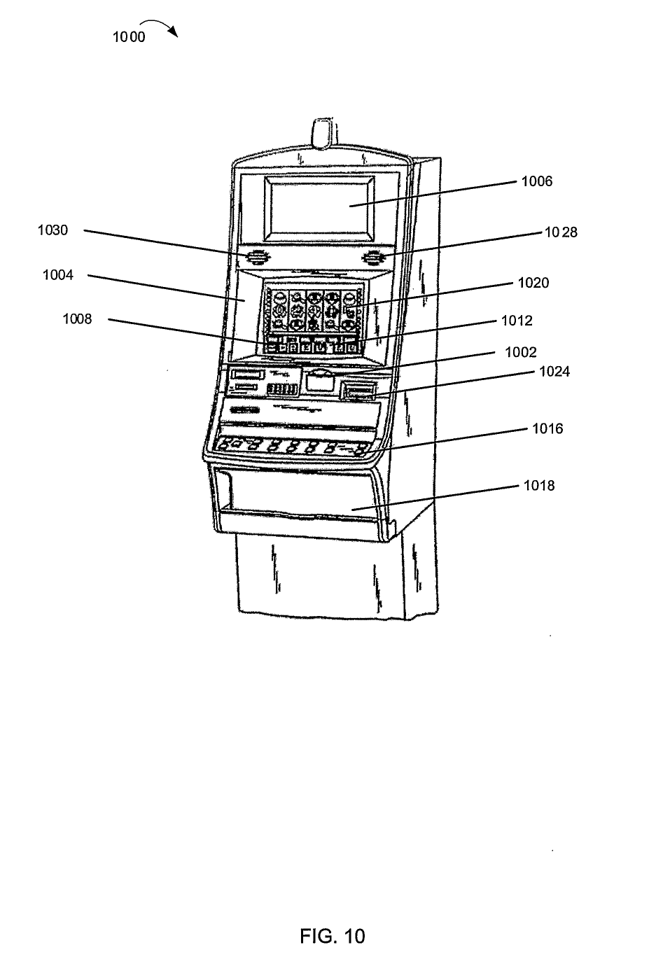

FIG. 10 is a perspective view of a gaming device, according to exemplary embodiments of the invention. As shown in FIG. 10, the gaming device 1000 can be a slot machine having the controls, displays, and features of a conventional slot machine. The gaming device 1000 can be operated while players are standing or seated. Additionally, the gaming device 1000 is preferably mounted on a console. However, it should be appreciated that the gaming device 1000 can be constructed as a pub-style tabletop game (not shown), which a player can operate while sitting. Furthermore, the gaming device 1000 can be constructed with varying cabinet and display designs. The gaming device 1000 can incorporate any primary game such as slot, poker, or keno, and additional bonus round games. The symbols and indicia used on and in the gaming device 1000 can take mechanical, electrical or video form.

As illustrated in FIG. 10, the gaming device 1000 includes a coin slot 1002 and bill acceptor 1024. Players can place coins in the coin slot 1002 and paper money or ticket vouchers in the bill acceptor 1024. Other devices can be used for accepting payment. For example, credit/debit card readers/validators can be used for accepting payment. Additionally, the gaming device 1000 can perform electronic funds transfers and financial transfers to procure monies from house financial accounts. When a player inserts money in the gaming device 1000, a number of credits corresponding to the amount deposited is shown in a credit display. After depositing the appropriate amount of money, a player can begin playing the game by pushing play button 1008. The play button 1008 can be any play activator used by the player to start a game or sequence of events in the gaming device 1000.

As shown in FIG. 10, the gaming device 1000 also includes a bet display 1012 and a “bet one” button 1016. The player places a bet by pushing the bet one button 1016. The player can increase the bet by one credit each time the player pushes the bet one button 1016. When the player pushes the bet one button 1016, the number of credits shown in the credit display 1006 decreases by one, and the number of credits shown in the bet display 1012 increases by one.

A player may “cash out” by pressing a cash out button. When a player cashes out, the gaming device 1000 dispenses a number of coins, corresponding to the number of remaining credits, into the coin tray 1018. The gaming device 1000 may employ other payout mechanisms such as credit slips, which are redeemable by a cashier, or electronically recordable cards, which track player credits.

The gaming device 1000 also includes one or more display devices. The embodiment shown in FIG. 10 includes a primary display unit 1004 and a secondary display unit 1006. In one embodiment, the primary display unit 1004 displays a plurality of reels 1020. In one embodiment, the gaming device displays three reels, while an alternative embodiment displays five reels. In one embodiment, the reels are in video form. According to embodiments of the invention, the display units can display any visual representation or exhibition, including moving physical objects (e.g., mechanical reels and wheels), dynamic lighting, and video images. In one embodiment, each reel 1020 includes a plurality of symbols such as bells, hearts, fruits, numbers, letters, bars or other images, which correspond to a theme associated with the gaming device 1000. Furthermore, as shown in FIG. 10, the gaming device 1000 includes a primary sound unit 1028 and a secondary sound unit 1030. In one embodiment, the primary and secondary sound units include speakers or other suitable sound projection devices. The gaming device 1000 can be adapted to include the system 100. Additionally, the gaming device 1000 is capable of performing the operations for processing game settings described herein.

1. A method comprising:
presenting a first game setting, wherein the first game setting includes a plurality of game elements;
selecting a game element from the plurality of game elements; and
presenting a second game setting, wherein presenting the second game setting includes enlarging the game element to show additional details of the game element; and
conducting a bonus event inside the second game setting.

2. The method of claim 1, wherein the game elements represent reel symbols for a video slot machine.

3. The method of claim 1, wherein the game symbols represents cards on a video poker machine.

4. The method of claim 1, wherein second game setting is presented on a primary display unit.

5. The method of claim 1, wherein the second game setting is presented on a secondary display unit.

6. The method of claim 1, wherein the presenting the second game setting further includes panning, raising, or lowering a display perspective.

7. A method comprising:
presenting a first bonus event setting, as part of a bonus event, by enlarging a game element of a base game setting;
determining whether the bonus event continues; and
if the bonus event continues, presenting a second bonus event setting by enlarging a portion of the first bonus event setting.

8. The method of claim 7 further comprising:
presenting a plurality of selection items in the first bonus event setting; and
receiving a player selection, wherein the player selection is used in determining whether the bonus event continues;
shrinking second bonus event setting; and
continuing a base game.

9. The method of 7, wherein the base game setting represents the reels of a video slot machine.

10. A method comprising:
presenting a first game setting that includes one or more game elements, wherein the presenting the first game setting is part of a base game;
presenting a second game setting, wherein the presenting the second game setting includes superimposing over the first game setting an enlargement of one of the game elements; and
conducting a game event inside the second game setting.

11. The method of claim 10, wherein the presenting the second game setting further includes reorienting the display perspective.

12. The method of claim 10, wherein the reorienting the display perspective can include panning, raising, and lowering the display perspective.

13. The method of claim 10, wherein the game event is part of a base game.

14. The method of claim 10, wherein the game event is part of a bonus event.

15. The method of claim 10 further comprising:
after presenting a first game setting, performing one or more of the following,
rearranging one or more of the game elements;
adding new game elements to the first game setting; and
removing one or more game elements from the first game setting.

16. The method of claim 10, wherein the game event is displayed on a secondary display device.

17. The method of claim 10, wherein the game event is presented on a primary display device.

18. An gaming device comprising:
a primary display unit to present a first game setting, wherein the first game setting includes a plurality of game elements;
a gaming control unit to select a game element from the plurality of game elements, and to cause a second game setting to be presented on the primary display unit, wherein presentation of the second game setting includes enlarging the game element to show additional details of the game element, and wherein a bonus event is conducted inside the second game setting.

19. The gaming device of claim 18, wherein certain of the plurality of game elements represent reel symbols of a video slot machine.

20. The gaming device of claim 18, wherein certain of the plurality of game elements represent cards of a video poker game.

21. A gaming device comprising:
a primary display device to present a first game setting that includes one or more game elements, wherein first game setting is associated with a base game, the primary display device also to present a second game setting by superimposing over the first game setting an enlargement of one of the game elements; and
a gaming control unit coupled to the primary display device, the gaming control unit to conduct a game event in the second game setting.

22. The gaming device of claim 21, wherein the gaming event is part of a bonus event.

23. The gaming device of claim 21, wherein the gaming event is part of the base game.
